(19) United States
(12) Patent Application Publication
(10) Pub. No.: US 2005/0277454 A1
(43) Pub. Date: Dec. 15, 2005

(54) Device and method for collecting chaff

(76) Inventor: Marcel Couture, Debden (CA)

Correspondence Address: ADE & COMPANY, 1700-360 MAIN STREET, WINNIPEG, MB, R3C3Z3, CA

(21) Appl. No.: 11/151,740

(22) Filed: Jun. 14, 2005

(30) Foreign Application Priority Data
Jun. 15, 2004 (CA) 2,470,907

(51) Int. Cl. A01F 12/30

(52) U.S. Cl. 460/111

(57) ABSTRACT

Chaff exiting a combine is collected by a device comprising a trough supported below the straw exit and chaff exit at the rear of a combine. Both straw and chaff are collected in the trough and mixed together by an auger in the trough which conveys the mixed straw and chaff through an open end of the trough to form a windrow deposited alongside the combine as the combine is operated in the forward working direction.

### FIELD OF THE INVENTION

The present invention relates to a chaff collecting device for collecting chaff exiting from a combine and more particularly relates to a device for depositing the chaff in a windrow with straw exiting the combine.

### BACKGROUND

In typical combines chaff is separated from grain in the combine and subsequently deposited on the ground. Due to the fine nature of chaff it is not readily possible to later collect this material. Accordingly it is typical to evenly spread the chaff across the ground instead of collecting the chaff despite recognizing the feed value thereof.

U.S. Pat. No. 3,860,101 to Anderson et al is one example of a device which collects chaff exiting a combine and deposits the chaff on top of a windrow of straw. The device requires a complex arrangement of multiple augers and pivoting parts. Accordingly the device is not readily adaptable to different types of combines. More particularly the device of Anderson does not collect straw. When using a rotary combine, the straw is finely chopped and spread in such a manner that the chaff collector of Anderson could not be deposited on a windrow for later collection.

### SUMMARY

According to one aspect of the present invention there is provided a chaff collecting device for a combine supported for movement across the ground in a forward working direction, the combine having a header at a front end and a straw exit and a chaff exit at a rear end from which straw and chaff exit the combine respectively, the device comprising:

an elongate trough;

mounting means for supporting the trough to extend transversely to the forward working direction below the straw exit and chaff exit on the combine for collecting straw and chaff exiting from the rear end of the combine in the trough; and

conveyor means supported in the trough for conveying straw and chaff collected in the trough through an open end of the trough.

According to a second aspect of the present invention there is provided a method of collecting chaff exiting a combine supported for movement across the ground in a forward working direction, the combine having a header at a front end and a straw exit and a chaff exit at a rear end from which straw and chaff exit the combine respectively, the method comprising:

providing an elongate trough;

collecting the straw and chaff in the trough by supporting the trough to extend transversely to the forward working direction below the straw exit and chaff exit on the combine; and

forming a windrow of mixed straw and chaff by conveying straw and chaff collected in the trough through an open end of the trough as the combine is operated in the forward working direction.

The use of a single trough is simple in construction and easily adaptable to various types of combines. Location of the trough permits collection of straw and chaff together for subsequently being deposited together through one end of the trough. A windrow is thus easily formed even when collecting finely chopped straw and chaff because of the tall and narrow nature of the windrow being deposited from the end of the trough. Use of the single trough is also easily adaptable for depositing the windrow spaced laterally outwardly along side the combine so that a double windrow may be formed when the combine returns in an opposing direction in a second pass over the field.

The trough preferably extends laterally outwardly past a wheel of the combine to the open end thereof from a left side of the combine when facing in the forward working direction. The mounting means preferably supports the trough to extend at an incline rearward and laterally outwardly towards the open end of the trough for clearance of the combine wheel.

The mounting means may freely suspend the open end of the trough for rearward or upward deflection thereof in relation to the combine. In this instance, it may be desirably to provide stop means which limits forward deflection of the open end of the trough into a wheel of the combine.

An opposing end of the trough opposite the open end may be pivotally supported on the combine at a front side thereof.

There may be provided a rear deflector, comprising a flexible sheet of material suspended from the combine, and spanning between a hood of the combine above the trough and a rear edge of the trough for capturing straw and chaff material blowing rearwardly out from the combine.

The conveyor means preferably comprises an auger supported in the trough which floats for upward deflection in relation to the trough at the open end thereof. A wear plate of material having a low coefficient of friction may line the trough adjacent the open end for supporting the auger thereon. A wear resistant edge on the auger is preferably located adjacent the wear plate for riding on the plate. A main portion of the auger between the wear plate and an end wall of the trough opposite the open end, may thus be suspended spaced above a bottom of the trough in the order of ¼ of an inch.

The conveyor means preferably communicates with the header of the combine to only operate the conveyor means when the header is operating.

The trough may include mounting apertures spaced along opposing edges thereof for adjustably securing the mounting means thereto.

There may be provided a spray mechanism for spraying liquid into the trough to be mixed with straw and chaff by the conveyor means.

The method described above according to the present invention may include locating the open end of the trough spaced laterally outwardly from the combine for forming the windrow along side the combine outwardly from a left side of the combine when facing in the forward working direction.

A liquid feed additive may be mixed with the straw and chaff prior to forming bales. In one embodiment, the method includes spraying the liquid feed additive into the trough adjacent an end wall of the trough opposite the open end. Alternatively, the liquid feed additive may be sprayed onto the straw and chaff when it is collected in a baler for forming bales. The liquid feed additive is preferably sprayed onto the straw and chaff between the pickup and the rollers of the baler in this instance.

### BRIEF DESCRIPTION OF THE DRAWINGS

In the accompanying drawings, which illustrate an exemplary embodiment of the present invention:

FIG. 1 is a perspective view of the chaff collecting device suspended from the rear hood of a combine with the rear deflector shown in dashed line.

FIG. 2 is a top plan view of the device mounted on a combine with the hood shown in dashed line for illustrating the components therebelow.

FIG. 3 is an end elevational view of the trough.

FIG. 4 is a perspective view of the end wall of the trough opposite the open free end.

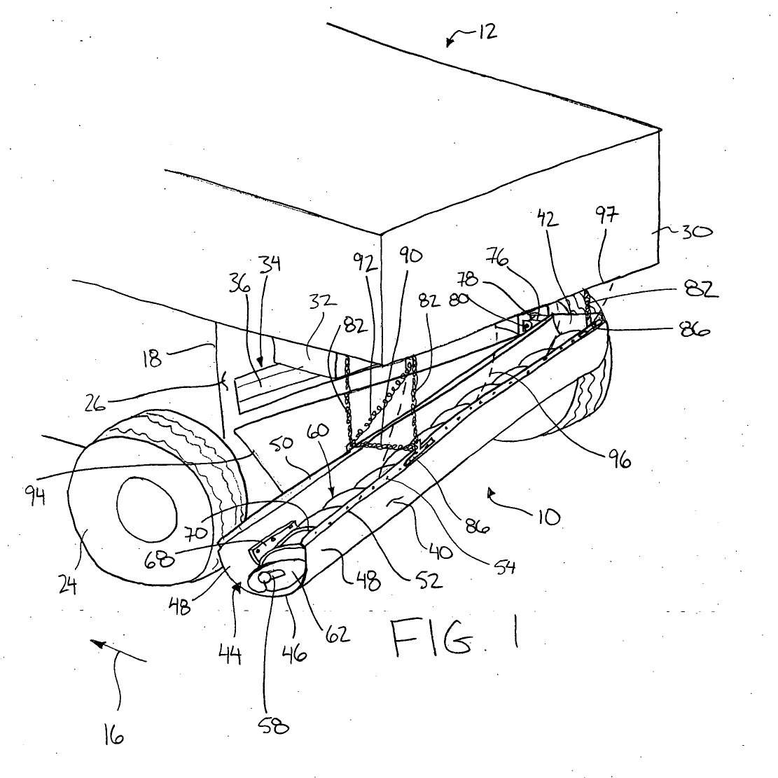

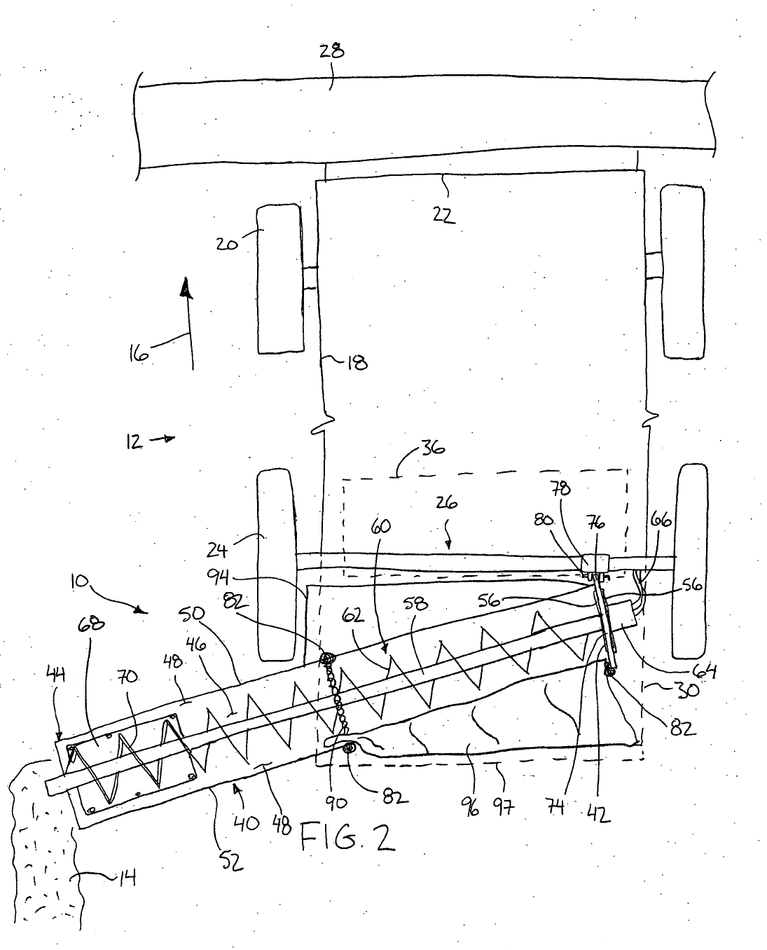

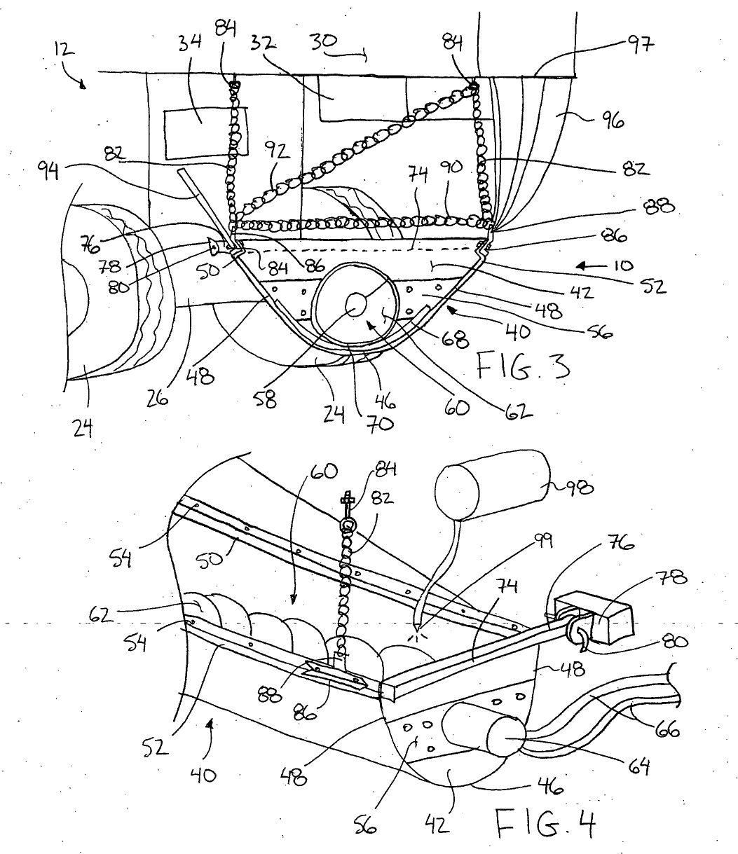

### DETAILED DESCRIPTION

Referring to the accompanying figures, there is illustrated a chaff collecting device generally indicated by reference numeral 10. The device 10 is particularly useful on a combine 12 to collect chaff to be mixed with straw exiting the combine for forming a windrow 14 of chaff and straw mixed together when the combine is operated in a forward working direction 16.

The combine includes a fame 18 supported on front wheels 20 at a front end 22 and supported on rear wheels 24 at a rear end 26. A header 28 is supported at the front end for harvesting. A hood 30 projects outwardly and rearwardly from the rear end 26 from which straw is deposited, typically from a chopper defining a straw exit 32 below the hood. A chaff exit 34 rearwardly of the sieves 36 of the combine is located below the straw exit 32 under the hood 30.

The device 10 comprises an elongate trough 40 spanning in a longitudinal direction between an end wall 42 at a first end of the trough and an opening at a free end 44 of the trough.

The trough 40 is formed by two overlapping layers of sheet metal which are curved at the center to define a curved bottom 46 extending between two flat side walls 48 in a V-shape in relation to one another. Each of the side walls 48 extends upwardly to a free edge at the respective front side 50 and rear side 52 of the trough. Each of the free edges is bent to form an angle defined by two flanges perpendicular to one another which are approximately 1½ inches wide. Mounting apertures 54 are provided at spaced positions along the angles in the free edges of the trough for supporting various mounting hardware thereon.

The end wall 42 is also formed of sheet metal and includes inner and outer reinforcing plates 56 spanning thereacross on inner and outer sides respectively. The plates and the end wall include a co-operating through-hole therein for receiving the shaft 58 of an auger 60 therethrough.

The auger 60 conveys material in the trough from the end wall to the free end thereof when operated. The auger floats on its flighting 62 at the free end of the trough to permit upward deflection in relation to the trough while being supported by the end wall 42 at an inner end.

A hydraulic motor 64 is mounted on the end wall outside the trough in communication with the shaft 58 of the auger for rotating the auger. The motor 64 is driven by hydraulics of the combine. The hydraulic fluid lines 66 of the motor are coupled to the hydraulics operating the header 28 of the combine so that the auger is configured in such a manner to only operate when the header is operating. The lines 66 include opposing male and female connectors formed thereon to ensure that the supply and return lines of the motor are connected in proper sequence for operating the auger in the proper direction.

The auger is supported in a floating configuration at the free end by a wear plate 68 which lines the interior of the trough adjacent the free end only. The wear plate 68 generally comprises a dense plastic material having a low coefficient of friction formed as a thin sheet so as to be sufficiently flexible to line the interior curved bottom of the trough. Opposing edges of the plate 68 are fastened to the trough side walls by suitable fasteners.

An edge of the flighting 62 of the auger which overlaps and engages the wear plate 68 includes a peripheral bead 70 formed thereon which has a smooth rounded surface for riding the wear plate 68 and supporting the weight of the auger thereon. The bead 70 prevents wear on the flighting and lowers friction of the auger resting on the wear plate.

A main portion of the auger between the wear plate at the free end and the motor at the end wall is suspended above the bottom of the trough a spacing in the order of approximately ¼ of an inch. The low friction material forming the wear plate 68 acts as a bearing at the free end while the motor 64 functions sufficiently as a bearing at the end wall of the trough.

The end wall includes a stabilizer bar 74 spanning thereacross at the top end of the trough in the form of square tubing for providing added structural support. An end portion 76 of the bar projects forwardly past the front edge of the trough for anchoring onto the frame of the combine. A horizontal aperture in the end portion of the bar 74 co-operates with apertures in a bracket 78 supported on an axle of the frame for securement by a suitable pin 80 coupled therebetween.

The pin 80 allows pivotal movement of the trough relative to the frame of the combine in an up and down motion at the rear edge about a horizontal axis of the pin 80. The bracket 78 is secured adjacent a right side of the combine when facing in the forward working direction so that the trough extends rearwardly and outwardly in a lateral direction towards the free end of the trough which extends past the opposing left side of the combine.

The rear end of the bar 74 is suspended from the hood of the combine by a suitable chain 82 extending therebetween. An eye hook 84 is secured to the frame of the combine for adjustable attachment of the chain 82 thereon such that the particular position of the trough relative to the combine can be adjusted somewhat.

The chain 82 secures to the rear edge of the trough adjacent the rear end of the stabilizer bar 74 by a suitable chain bracket 86. The chain bracket includes an angle which can be secured to the mounting apertures 54 along the angles formed in the trough at one of various positions spaced therealong. An upright flange 88 on the chain bracket 86 includes a suitable aperture therein for securement to the chain 82.

Adjacent the left side of the combine, between ends of the trough, an additional pair of the chains 82 extend vertically from the opposing side walls of the trough for anchoring to the hood of the combine by respective hooks 84. The free end of the trough thus hangs freely by the chains to readily permit upward and rearward deflection in relation to the combine in the event that obstacles are encountered during operation of the combine.

In addition to the vertical chains 82 suspending the trough near the free end, a cross chain 90 extends between the vertical chains at the opposing edges of the trough for maintaining the shape of the trough. A stop chain 92 extends diagonally between the two vertical chains 82 from the hood of the combine above the rear edge of the trough at the hook 84 to the front edge of the trough. The stop chain thus limits forward deflection of the trough into the wheel adjacent the free end of the trough.

A front deflector 94 is coupled to the front edge of the trough to extend upwardly and outwardly therefrom generally parallel to the front side wall of the trough to span between the trough and the chaff exit rearward of the sieves of the combine. Due to the rearward and outward incline of the trough towards the free end thereof, the front deflector is triangular in shape to fully span the gap between the trough and the chaff exit. The front deflector 94 includes apertures along a bottom edge thereof for securement to the apertures 54 in the trough. The deflector 94 is formed of sheet metal which can easily be cut by the user when fitting to a particular type of combine for permitting the trough to be adapted to various types of combines.

A rear deflector 96 is also provided in the form of a flexible drape of canvas material which is secured along a top edge thereof to a rear bottom edge 97 of the hood of the combine. The deflector hangs freely from the hood such that a lower free edge of the deflector overlaps the interior of the rear side wall of the trough. In this arrangement any straw or chaff which is blown rearwardly from the combine is collected by the deflector and is forced to drop down into the trough for mixing by the auger to be subsequently conveyed through the open free end of the auger into a windrow.

A spray mechanism for adding liquid feed, for example molasses, to the mixture of straw and chaff is provided by supporting a tank 98 on the combine. A pump on the tank 98 communicates with a suitable nozzle 99 directed into the trough adjacent the end wall at the motor. This ensures that any liquid sprayed into the trough is fully mixed with the straw and chaff by the time it reaches the open free end.

In use the trough is suspended below the chaff and straw exits on the combine with the deflectors 94 and 96 configured to direct the straw and chaff exiting the combine down into the trough. The auger mixes and conveys the straw and chaff through the open free end of the trough to form a tall narrow windrow along side the combine as the combine is operated in the forward working direction. Spraying the liquid feed additive into the straw and chaff in the trough ensures thorough mixing to produce a high feed value bale once the windrow is baled with a suitable baler. In further embodiments, the components of the sprayer mechanism may instead be mounted on the baler for spraying the liquid feed additive into the mixture of straw and chaff as it is being collected for baling by the baler. The liquid feed additive is sprayed onto the straw and chaff between the pickup and the rollers of the baler in this instance.

In further embodiments, the rear deflector may include an upper portion comprising the flexible canvas material described above and a lower portion comprising a lower rigid deflector panel. The lower rigid deflector panel is secured along the rear edge of the trough using suitable fasteners received through the apertures in the edge of the trough. The upper portion of flexible canvas is suspended from the rear edge of the hood of the combine and overlaps the interior surface of the lower rigid panel deflector to direct straw material and chaff downwardly into the trough. The use of the additional lower rigid deflector is particularly suited for combines having a hood which is suspended very high above the ground.

While some embodiments of the present invention have been described in the foregoing, it is to be understood that other embodiments are possible within the scope of the invention. The invention is to be considered limited solely by the scope of the appended claims.

1. A chaff collecting device for a combine supported for movement across the ground in a forward working direction, the combine having a header at a front end and a straw exit and a chaff exit at a rear end from which straw and chaff exit the combine respectively, the device comprising:
an elongate trough;
mounting means for supporting the trough to extend transversely to the forward working direction below the straw exit and chaff exit on the combine for collecting straw and chaff exiting from the rear end of the combine in the trough; and
conveyor means supported in the trough for conveying straw and chaff collected in the trough through an open end of the trough.

2. The device according to claim 1 wherein the trough extends laterally outwardly past a wheel of the combine to the open end thereof.

3. The device according to claim 2 wherein the open end of the trough extends laterally from a left side of the combine when facing in the forward working direction.

4. The device according to claim 1 wherein the mounting means freely suspends the open end of the trough for rearward or upward deflection thereof in relation to the combine.

5. The device according to claim 4 wherein there is provided stop means which limits forward deflection of the open end of the trough into a wheel of the combine.

6. The device according to claim 4 wherein an opposing end of the trough opposite the open end is pivotally supported on the combine at a front side thereof.

7. The device according to claim 1 wherein the mounting means supports the trough to extend at an incline rearward and laterally outwardly towards the open end of the trough.

8. The device according to claim 1 wherein there is provided a rear deflector spanning between a hood of the combine above the trough and a rear edge of the trough.

9. The device according to claim 8 wherein the rear deflector comprises a flexible sheet of material suspended from the combine.

10. The device according to claim 1 wherein the conveyor means comprises an auger supported in the trough which floats for upward deflection in relation to the trough at the open end thereof.

11. The device according to claim 10 wherein there is provided a wear plate of material having a low coefficient of friction lining the trough adjacent the open end upon which the auger rests.

12. The device according to claim 11 wherein there is provided a wear resistant edge on the auger adjacent the wear plate.

13. The device according to claim 11 wherein a main portion of the auger between the wear plate and an end wall of the trough opposite the open end, is suspended spaced above a bottom of the trough.

14. The device according to claim 1 wherein the conveyor means communicates with the header of the combine to only operate the conveyor means when the header is operating.

15. The device according to claim 1 wherein the trough includes mounting apertures spaced along opposing edges thereof for adjustably securing the mounting means thereto.

16. The device according to claim 1 wherein there is provided a spray mechanism for spraying liquid into the trough to be mixed with straw and chaff by the conveyor means.

17. A method of collecting chaff exiting a combine supported for movement across the ground in a forward working direction, the combine having a header at a front end and a straw exit and a chaff exit at a rear end from which straw and chaff exit the combine respectively, the method comprising:
providing an elongate trough;
collecting the straw and chaff in the trough by supporting the trough to extend transversely to the forward working direction below the straw exit and chaff exit on the combine; and
forming a windrow of mixed straw and chaff by conveying straw and chaff collected in the trough through an open end of the trough as the combine is operated in the forward working direction.

18. The method according to claim 17 including locating the open end of the trough spaced laterally outwardly from the combine for forming the windrow along side the combine.

19. The method according to claim 18 including forming the windrow laterally outwardly from a left side of the combine when facing in the forward working direction.

20. The method according to claim 17 including mixing a liquid feed additive with the straw and chaff prior to forming bales.

21. The method according to claim 20 including spraying the liquid feed additive into the trough adjacent an end wall of the trough opposite the open end.

22. The method according to claim 20 including spraying the liquid feed additive onto the straw and chaff within a baler used for baling the straw and chaff.
